(19) United States
(12) Patent Application Publication
(10) Pub. No.: US 2008/0135363 A1
(43) Pub. Date: Jun. 12, 2008

(54) Damper Fixing Mechanism

(75) Inventor: Shioto Tokumoto, Moriya-shi (JP)

Correspondence Address: PAUL A. GUSS;PAUL A. GUSS ATTORNEY AT LAW, 775 S 23RD ST FIRST FLOOR SUITE 2, ARLINGTON, VA, 22202, US

(73) Assignee: SMC KABUSHIKI KAISHA, Tokyo (JP)

(21) Appl. No.: 11/951,309

(22) Filed: Dec. 5, 2007

(30) Foreign Application Priority Data
Dec. 6, 2006 (JP) 2006-329546

(51) Int. Cl. F16F 9/36

(52) U.S. Cl. 188/322.18

(57) ABSTRACT

A piston is slidably displaced inside of a cylinder tube, and damper grooves are provided on both end surfaces of the piston, which extend substantially perpendicular to the axis thereof. The damper grooves penetrate along the end surfaces of the piston, and respective dampers formed from an elastic material are installed therein. On the dampers, base members thereof are inserted into first grooves that make up the damper grooves, and guide members, which are expanded in width with respect to the base members, are inserted into second grooves that lie adjacent to and are expanded in width with respect to the first grooves.

### BACKGROUND OF THE INVENTION

1. Field of the Invention

The present invention relates to a damper fixing mechanism for fixing dampers in a fluid pressure cylinder, in which a piston is displaced along an axial direction thereof under the supply of a pressure fluid, whereby the dampers buffer shocks occurring when the piston abuts against cover members.

2. Description of the Related Art

Heretofore, a fluid pressure cylinder, having a piston therein displaced under the supply of a pressure fluid, has been used, for example, as a transport device for transporting various workpieces and the like. In such a fluid pressure cylinder, a construction is provided in which a piston is disposed displaceably inside of a cylinder chamber defined inside a tubular shaped cylinder body, and cushion dampers are provided, which are capable of buffering shocks occurring when the piston abuts against a head cover and a rod cover that are installed respectively on both ends of the cylinder body.

Such a cushion damper, for example as disclosed in Japanese Laid-Open Utility Model Publication No. 07-34239, is formed from an elastic material such as rubber or the like. Cushion dampers are provided on both end surfaces of the piston, and sandwiched and gripped integrally by a piston rod and a nut connected to the piston. In addition, a structure is provided in which the piston is displaced along the cylinder body and shocks are buffered upon abutment of the cushion dampers.

Further, in Japanese Laid-Open Patent Publication No. 09-303320, gaskets, which function as cushion dampers, are sandwiched between ends of the cylinder body and respective covers, and a structure is provided in which the piston is displaced along the cylinder body and shocks are buffered upon abutment of the piston against the gaskets.

Incidentally, the cushion dampers according to Japanese Laid-Open Utility Model Publication No. 07-034239 are formed with substantially circular shapes in cross section. However, for example, as disclosed in Japanese Laid-Open Patent Publication No. 09-303320, with a flattened fluid pressure cylinder, having a cross sectional elliptically shaped piston formed with the major axis thereof arranged in the horizontal direction, and which is equipped with a cross sectional elliptically shaped cylinder chamber in which the piston is disposed, because the height dimension of the piston and covers is made smaller, it is difficult to ensure equivalency with the case in which the cross sectional area of the cushion damper is formed substantially circular in cross section. As a result, the shock absorbing ability of the damper, with which the damper is capable of buffering shocks exerted with respect to the piston, tends to be degraded.

### SUMMARY OF THE INVENTION

A general object of the present invention is to provide a damper fixing mechanism having a predetermined shock absorbing ability and a simple structure, by which dampers can easily and reliably be installed with respect to a piston or cover members.

The above and other objects features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is an exterior perspective view of a fluid pressure cylinder in which a damper fixing mechanism is applied according to an embodiment of the present invention;

FIG. 2 is an exploded perspective view of the fluid pressure cylinder shown in FIG. 1;

FIG. 3 is an overall vertical cross sectional view of the fluid pressure cylinder shown in FIG. 1;

FIG. 4 is an exploded vertical cross sectional view of the fluid pressure cylinder shown in FIG. 3;

FIG. 5A is an enlarged perspective view of a cushion damper shown in FIG. 2, and FIG. 5B is an enlarged perspective view of the cushion damper of FIG. 5A, as viewed from a different direction.

FIG. 6 is a side surface view, as viewed from a head cover side of the fluid pressure cylinder shown in FIG. 1;

FIG. 7 is a side surface view, as viewed from a rod cover side of the fluid pressure cylinder shown in FIG. 1;

FIG. 8 is a simple plan view of a locking ring;

FIG. 9 is a simple perspective view showing the cushion damper according to a first modified example;

FIG. 10 is a partial vertical cross sectional view showing a state in which the cushion damper of FIG. 9 is installed with respect to damper grooves of a piston;

FIG. 11 is a simple perspective view showing the cushion damper according to a second modified example;

FIG. 12 is a plan view of a piston in which the cushion damper of FIG. 11 is installed;

FIG. 13 is an exterior perspective view showing a state in which a locking ring according to a modified example is installed in the fluid pressure cylinder;

FIG. 14 is a simple plan view of the locking ring shown in FIG. 13;

FIG. 15 is a side surface view, as viewed from a head cover side of the fluid pressure cylinder shown in FIG. 13; and

FIG. 16 is a side surface view, as viewed from a rod cover side of the fluid pressure cylinder shown in FIG. 13.

### DESCRIPTION OF THE PREFERRED EMBODIMENTS

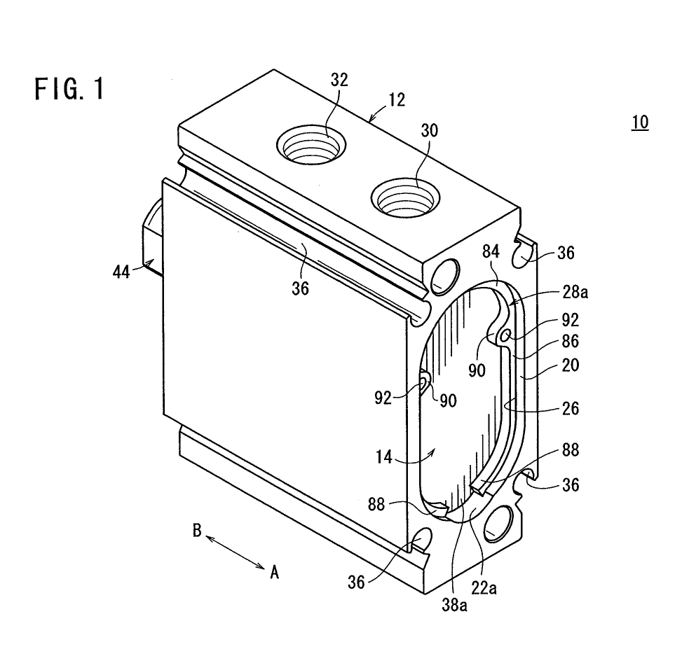

In FIG. 1, reference numeral 10 indicates a fluid pressure cylinder equipped with dampers, to which the damper fixing mechanism according to an embodiment of the present invention is applied.

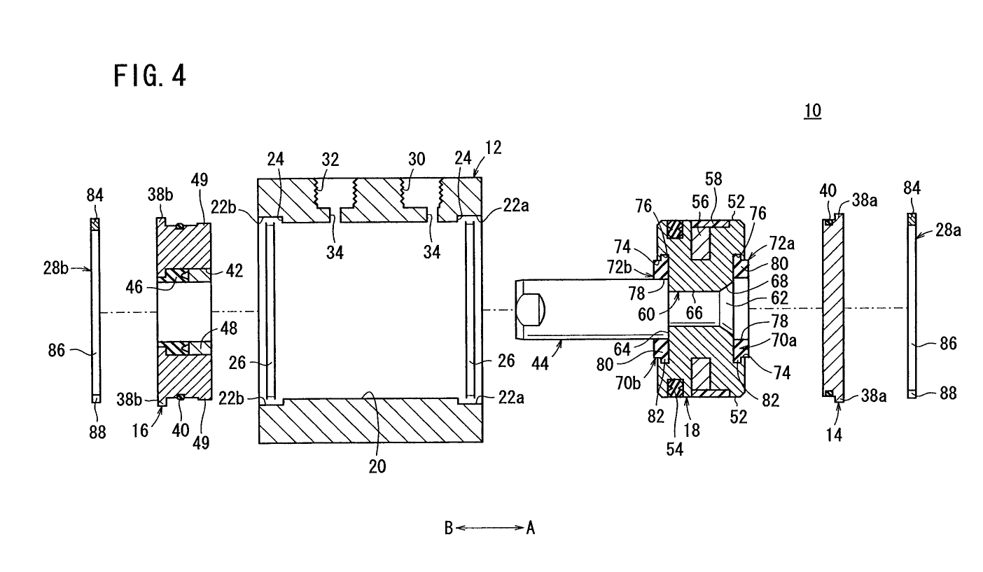

As shown in FIGS. 1 to 4, the fluid pressure cylinder 10 includes a tubular shaped cylinder tube (cylinder body) 12, a head cover (cover member) 14 installed on one end of the cylinder tube 12, a rod cover (cover member) 16 installed on the other end of the cylinder tube 12, and a piston 18 disposed displaceably inside the cylinder tube 12.

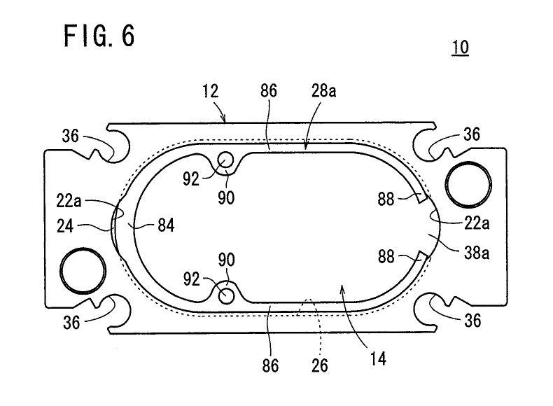

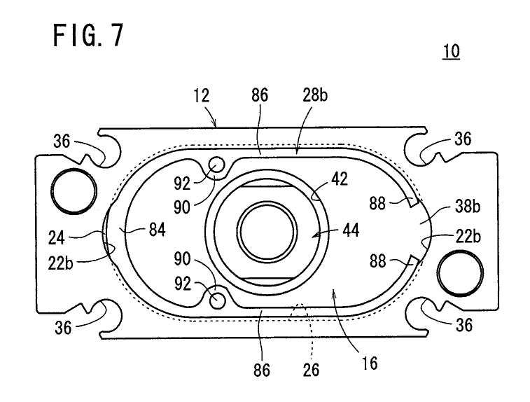

The cylinder tube 12 is constructed with a substantially rectangular shape in cross section, having a cylinder hole 20, which is substantially elliptically shaped in cross section, penetrating in the axial direction inside the cylinder tube 12. The cylinder hole 20 is formed so as to be substantially elliptically shaped in cross section such that the major axis thereof lies substantially in the horizontal direction (when the fluid pressure cylinder 10 is oriented as shown in FIGS. 6 and 7), and wherein on both ends thereof, a pair of recesses 22a, 22b are provided, which are expanded in width in directions away from the center of the cylinder hole 20. The pairs of recesses 22a, 22b are formed respectively on both end portions, such that the recesses 22a, 22b are recessed in arcuate shapes and lie substantially in a horizontal direction with respect to the flat-shaped cylinder tube 12. More specifically, the recesses 22a, 22b are arranged facing each other, while being arcuately recessed in directions away from the center of the cylinder hole 20. The radius of curvature of the recesses 22a, 22b is set to be smaller than the radius of curvature on both end portions of the cylinder hole 20.

Specifically, the inner circumferential surface of the cylinder hole 20 is formed such that both end portions of the cylinder hole 20 are made larger only at the portions of the recesses 22a, 22b. Further, stepped portions 24 are disposed between the recesses 22a, 22b and a central region along the axial direction of the cylinder hole 20.

Further, ring grooves 26 are formed respectively on both ends of the cylinder hole 20 along the inner circumferential surface thereof while facing the recesses 22a, 22b. Locking rings 28a, 28b are installed respectively into the ring grooves 26.

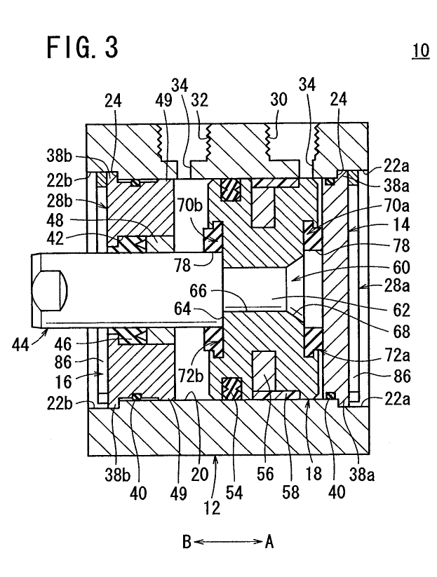

On the other hand, a pair of first and second fluid ports 30, 32 through which a pressure fluid is supplied and discharged is formed on an outer side surface of the cylinder tube 12. The first and second fluid ports 30, 32 are separated a predetermined distance along the axial direction of the cylinder tube 12, and communicate respectively with the cylinder hole 20 through communication passages 34 (see FIG. 3). Accordingly, the pressure fluid supplied to the first and second fluid ports 30, 32 passes through the communication passages 34 and is introduced to the interior of the cylinder hole 20. Further, a plurality of sensor grooves 36, in which sensors may be installed that are capable of detecting the position of the piston 18, extend along the axial direction (in the direction of the arrows A and B) on the outer side surface of the cylinder tube 12.

The head cover 14 is formed with a substantially elliptical shape in cross section corresponding to the shape of the cylinder hole 20, and is installed in one end side (in the direction of the arrow A) of the cylinder tube 12. A pair of projections 38a are formed, which project a given length from the outer circumferential surface thereof on both side portions of the head cover 14 corresponding to the recesses 22a of the cylinder hole 20. The projections 38a are disposed on both side portions of the head cover 14, bulging outwardly with arcuate shapes and with a predetermined radius of curvature corresponding to that of the recesses 22a (see FIG. 6).

Further, an o-ring 40 is installed in an annular groove on an outer circumferential surface of the head cover 14. When the head cover 14 is installed in the cylinder hole 20 of the cylinder tube 12, an airtight condition is maintained by abutment of the o-ring 40 against the inner circumferential surface of the cylinder hole 20.

Similar to the head cover 14, the rod cover 16 is formed with a substantially elliptical shape in cross section corresponding to the shape of the cylinder hole 20, and is installed in the other end side (in the direction of the arrow B) of the cylinder tube 12. In addition, a pair of projections 38b are formed, which project a given length from the outer circumferential surface thereof on both side portions corresponding to the recesses 22b of the cylinder hole 20. The projections 38b are disposed on both side portions of the rod cover 16, bulging outwardly with arcuate shapes, and with a predetermined radius of curvature corresponding to that of the recesses 22b (see FIG. 7).

Further, a rod hole 42, which penetrates along the axial direction, is formed at a substantially central portion of the rod cover 16, and a piston rod 44 connected to the piston 18 is inserted through the rod hole 42. A rod packing 46 and a bush 48 are installed on an inside portion of the rod hole 42, thereby maintaining an airtight condition at the interior of the cylinder hole 20.

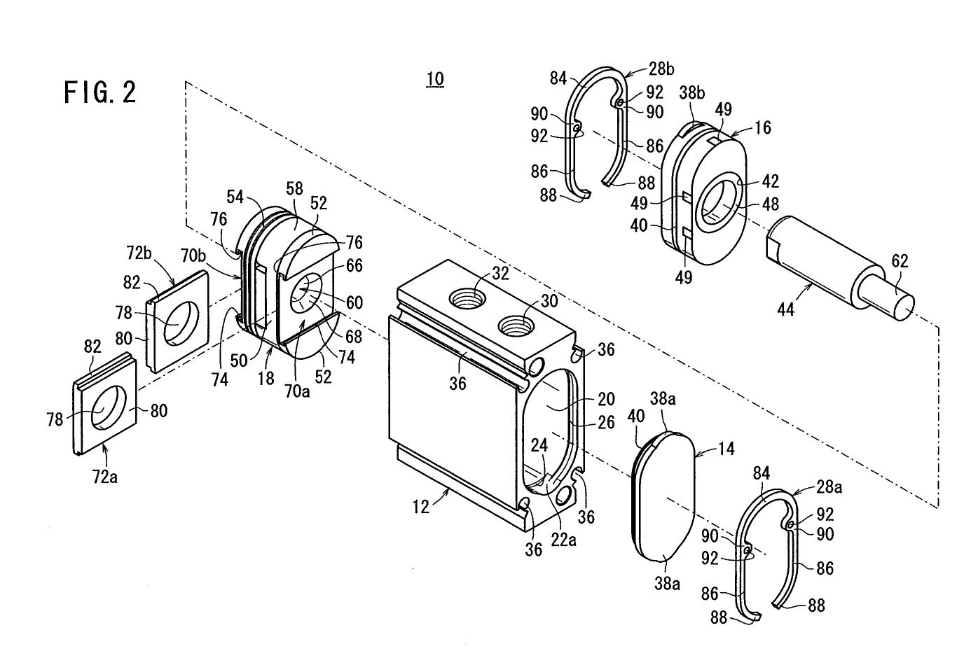

Furthermore, an o-ring 40 is installed on the outer circumferential surface of the rod cover 16, in an annular groove at a substantially central portion in the axial direction of the rod cover 16. A plurality (for example, six) guide members 49, which are separated by predetermined distances, are disposed on an end portion symmetrical with the projections 38b while sandwiching the annular groove therebetween (see FIG. 2). The guide members 49 project at a given height with respect to the outer circumferential surface, such that when the rod cover 16 is inserted into the cylinder hole 20, the guide members 49 slidably contact the inner circumferential surface of the cylinder hole 20. That is, the guide members 49 are formed with shapes that correspond to the inner circumferential surface of the cylinder hole 20. The quantity of guide members 49 is not restricted to any particular number, so long as it is equal to or greater than four, and the guide members 49 are separated mutually from each other at predetermined distances.

Owing thereto, when the rod cover 16 is inserted into the cylinder hole 20, the rod cover 16 is guided with respect to the cylinder hole 20 by the plurality of guide members 49, and the rod cover 16 is properly positioned radially within the cylinder hole 20. As a result, the center of the cylinder hole 20 and the axial line of the rod cover 16 can be made to coincide with each other, and the piston rod 44, which is inserted through the cylinder hole 20, can be inserted with respect to the rod hole 42 of the rod cover 16 and pass therethrough accurately and with high precision.

The piston 18 is formed with a substantially elliptical shape in cross section. A pair of planar surface sections 50 are provided on the outer circumferential surface of the piston 18, and a pair of arcuate sections 52, which expand outwardly on outer sides with a given radius of curvature, are connected to both end portions of the planar surface sections 50. A piston packing 54 and a magnetic body 56 are installed on the outer circumferential surface, and the magnetic body 56 is covered by a piston cover 58. An outer circumferential surface of the piston cover 58 lies substantially on the same surface as the outer circumferential surface of the piston 18.

Further, a piston hole 60 that penetrates in the axial direction (in the direction of the arrows A and B) is formed on an inner portion of the piston 18, and a connecting portion 62 of the piston rod 44 is inserted through the piston hole 60. The piston hole 60 includes a first hole 64 which is opened toward the side of the rod cover 16 (in the direction of the arrow B), a second hole 66 adjacent to the first hole 64 and which is reduced in diameter, and a tapered hole 68 adjacent to the second hole 66 and which gradually expands in diameter toward the side of the head cover 14 (in the direction of the arrow A). The first and second holes 64, 66 and the tapered hole 68 are mutually connected with one another.

On the other hand, on both end surfaces of the piston 18, a pair of damper grooves 70a, 70b is formed, the damper grooves 70a, 70b being recessed at a given depth. A pair of cushion dampers 72a, 72b (hereinafter referred to simply as dampers) are installed respectively into each of the damper grooves 70a, 70b.

The damper grooves 70a, 70b extend substantially perpendicular to the axis of the piston 18 along both end surfaces and penetrate between the pair of planar surface sections 50. In addition, the damper grooves 70a, 70b include first grooves 74 that are formed adjacent to both end surfaces of the piston 18, and second grooves 76, which are recessed further inwardly from both end surfaces than the first grooves 74, and which are expanded in width with respect to the first grooves 74. The second grooves 76 are expanded in width by a predetermined width, in directions substantially perpendicular to the direction in which the damper grooves 70a, 70b extend.

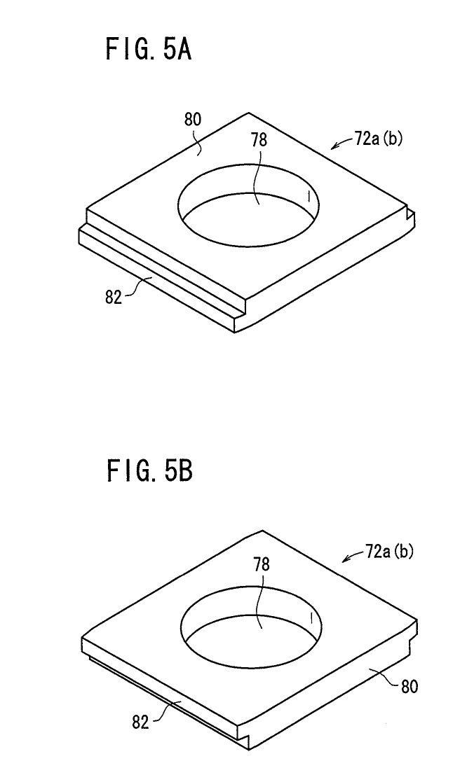

As shown in FIGS. 5A and 5B, the dampers 72a, 72b are substantially rectangular plate shaped bodies in cross section, formed from an elastic material such as urethane rubber or the like, for example, and are disposed respectively so as to project a predetermined length outwardly from both end surfaces of the piston 18. The dampers 72a, 72b include holes 78, which penetrate along the axial direction substantially in the center thereof, base members 80 that are inserted respectively into the damper grooves 70a, 70b, and guide members 82 that are expanded in width with respect to the base members 80, and which are inserted respectively into the second grooves 76 of the damper grooves 70a, 70b.

Further, the dampers 72a, 72b are formed with cross sectional shapes that are substantially the same as the cross sectional shapes of the damper grooves 70a, 70b, such that the guide members 82 are inserted into the second grooves 76, whereas the base members 80 are inserted into the first grooves 74 and project outwardly, respectively, a given length with respect to both end surfaces of the piston 18.

Furthermore, the lengthwise dimension of the dampers 72a, 72b is set substantially equal to the lengthwise dimension of the damper grooves 70a, 70b. Owing thereto, when the dampers 72a, 72b are installed in the damper grooves 70a, 70b, the end surfaces of the dampers 72a, 72b do not project outwardly from the planar surface sections 50 of the piston 18, and the holes 78 thereof are disposed so as to face the piston hole 60 of the piston 18. In addition, the piston rod 44 is inserted through the hole 78 of the damper 72b that is disposed in the piston 18 on the side of the rod cover 16 (in the direction of the arrow B). The damper grooves 70a, 70b are covered completely by the dampers 72a, 72b, as a result of installing the dampers 72a, 72b therein.

In this manner, concerning the dampers 72a, 72b, because the guide members 82, which are expanded in width with respect to the base members 80, engage with respect to the second grooves 76 of the damper grooves 70a, 70b, relative displacements of the dampers 72a, 72b in the axial direction with respect to the piston 18 are regulated. Stated otherwise, the dampers 72a, 72b are installed while being capable of moving only in directions substantially perpendicular to the axis of the piston 18, along which the damper grooves 70a, 70b extend.

In addition, the dampers 72a, 72b abut respectively against the head cover 14 and the rod cover 16 before the piston 18 does, at the displacement terminal end positions of the piston 18 upon displacement of the piston 18 along the cylinder tube 12. Owing thereto, shocks are appropriately buffered and absorbed by the dampers 72a, 72b when the piston 18 abuts against the head cover 14 and the rod cover 16, and the impact of such shocks on the piston 18 is prevented. Stated otherwise, the dampers 72a, 72b function as buffering mechanisms, capable of absorbing and buffering the impact of shocks to the piston 18.

The piston rod 44 is formed from a shaft having a predetermined length along the axial direction. A connecting portion 62 that is radially reduced in diameter is formed on one end thereof, which is connected to the piston 18. The connecting portion 62 is inserted through the second hole 66 and the tapered hole 68 of the piston hole 60. On the other hand, the other end of the piston rod 44 is inserted through the rod hole 42 and is supported displaceably by the bush 48 and the rod packing 46.

Further, concerning the piston rod 44, the boundary region thereof with the connecting portion 62 engages with a stepped portion between the first hole 64 and the second hole 66, whereby the piston rod 44 is positioned with respect to the piston 18. Furthermore, by applying a pressing force to the end of the connecting portion 62, which is inserted into the tapered hole 68, toward the side of the second hole 66 (in the direction of the arrow B), the end portion thereof is plastically deformed along the tapered hole 68 and is expanded in diameter. As a result, the connecting portion 62 is caulked onto the tapered hole 68 of the piston 18 through the deformed end portion thereof, thereby connecting the piston rod 44 and the piston 18 together. Further, the connecting portion 62 of the piston rod 44 does not project beyond the end surface of the piston 18, and is caulked in such a way that it forms substantially the same surface with the end surface of the piston 18.

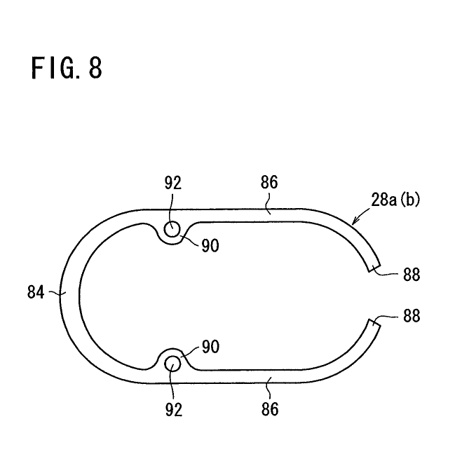

As shown in FIG. 8, locking rings 28a, 28b are formed with substantially U-shaped cross sections from a metallic material, and are installed respectively into a pair of ring grooves 26, which are formed in the cylinder hole 20 of the cylinder tube 12. The locking rings 28a, 28b are formed with shapes corresponding to the ring grooves 26, and include a bent section 84, which is bent at a predetermined radius of curvature, a pair of arm sections 86 that extend in substantially straight lines from both ends of the bent section 84, and a pair of claw sections 88 disposed on ends of the arm sections 86, which are bent at a predetermined radius of curvature and are mutually separated a predetermined distance from each other. The claw sections 88 are positioned in confronting relation to the bent section 84 sandwiching the arm sections 86 therebetween, and the locking rings 28a, 28b possess a certain elasticity, which urges the pair of claw sections 88 themselves mutually in directions to separate a predetermined distance away from each other.

The bent section 84 is formed with a predetermined radius of curvature corresponding to both side portions of the cylinder hole 20, whereas the claw sections 88, similarly, are formed with a predetermined radius of curvature that corresponds to the side portions of the cylinder hole 20.

Bulging portions 90, which bulge toward the inner side surface in a mutually facing relation to each other, are included on the arm sections 86. Jig holes 92 are formed respectively in the bulging portions 90. Specifically, the bulging portions 90 and the jig holes 92 are disposed at positions on the arm sections 86 coinciding with sides of the bent section 84. In addition, by inserting an unillustrated jig into the pair of jig holes 92 and displacing the bulging portions 90 along with the jig holes 92 mutually in directions to approach one another, the arm sections 86 and the claw sections 88 can be elastically deformed so as to approach mutually toward each other about the juncture at the bent section 84.

Specifically, the bent section 84 and the claw sections 88 of the locking rings 28a, 28b are made to engage with both side portions of the cylinder hole 20 in the ring grooves 26.

In addition, the locking rings 28a, 28b are installed respectively into the ring grooves 26 after the head cover 14 and the rod cover 16 have been installed with respect to the cylinder hole 20 of the cylinder tube 12. Accordingly, the head cover 14 and the rod cover 16 are fixed by means of the projections 38a, 38b thereof and the locking rings 28a, 28b. At this time, the head cover 14 and the rod cover 16 do not protrude from the end surfaces of the cylinder tube 12.

The fluid pressure cylinder 10, to which the damper according to the present invention is applied, basically is constructed as described above. Next, an explanation shall be given concerning assembly of the fluid pressure cylinder 10.

First, when the dampers 72a, 72b are installed onto the piston 18, the guide members 82 of the dampers 72a, 72b are arranged on respective sides of the piston 18, and the dampers 72a, 72b are disposed in the end sides of the opened damper grooves 70a, 70b. Additionally, the dampers 72a, 72b are slidably displaced toward the piston 18 to insert the guide members 82 into the second grooves 76. Specifically, the dampers 72a, 72b are displaced along the damper grooves 70a, 70b in directions substantially perpendicular to the axis of the piston 18. Owing thereto, the guide members 82 that make up the dampers 72a, 72b are inserted into the second grooves 76, and along therewith, the base members 80 thereof are inserted into the first grooves 74.

Additionally, installation of the dampers 72a, 72b is completed when the end portions of the dampers 72a, 72b are moved into agreement and become flush with the planar surface sections 50 of the piston 18. In this case, the holes 78 of the dampers 72a, 72b are positioned coaxially with the piston hole 60 of the piston 18, and the dampers 72a, 72b protrude, at a predetermined height, with respect to both end surfaces of the piston 18 (see FIG. 3).

In this manner, by slidably displacing the dampers 72a, 72b in directions substantially perpendicular to the axis of the piston 18 with respect to the damper grooves 70a, 70b provided on both end surfaces of the piston 18, the dampers 72a, 72b can be installed easily. In addition, because the guide members 82 engage within the second grooves 76, the dampers 72a, 72b are not displaceable in axial directions with respect to the piston 18.

Further, although the dampers 72a, 72b are displaceable in directions substantially perpendicular to the axis of the piston 18, upon insertion of the piston 18 into the cylinder hole 20 of the cylinder tube 12, owing to the fact that the outer circumferential surface of the piston 18 becomes surrounded by the inner circumferential surface of the cylinder hole 20, displacement of the dampers 72a, 72b in directions substantially perpendicular to the axis of the piston 18 also is regulated.

As a result, the dampers 72a, 72b normally are displaced integrally and in unison with displacement of the piston 18, thereby enabling shocks imparted to the piston 18 at the displacement terminal end positions of the piston 18 to be reliably and suitably buffered.

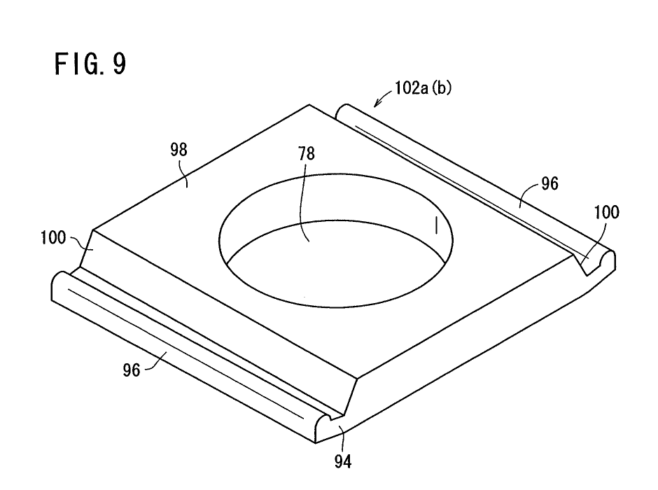

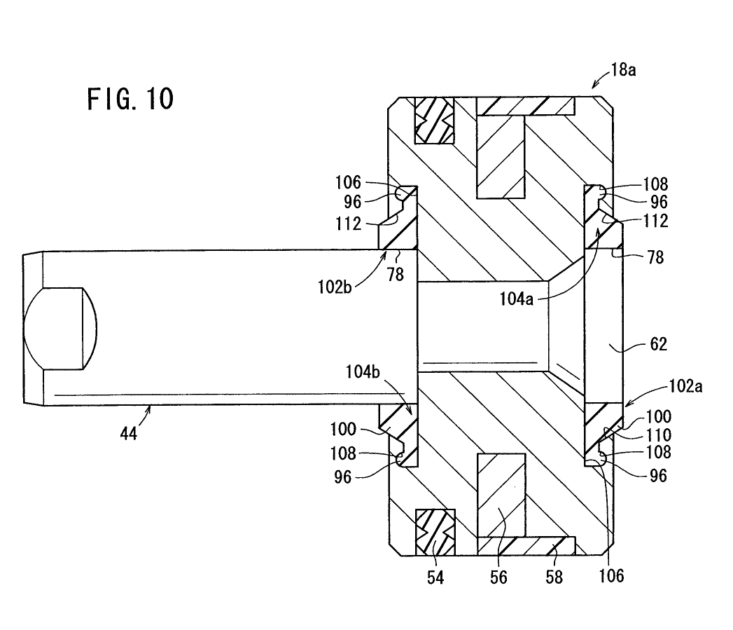

Further, in place of the above-mentioned dampers 72a, 72b, the cushion dampers 102a, 102b (hereinafter simply referred to as dampers 102a, 102b) shown in FIGS. 9 and 10, having jutting portions 96 on the guide members 94, and further having tapered portions 100 on side surfaces of the base member 98, may also be used.

The dampers 102a, 102b are provided with jutting portions 96, which bulge outwardly with substantially semicircular cross sectional shapes toward the side of the base member 98 on side surfaces of the guide members 94, and wherein the jutting portions 96 extend along the guide members 94.

On the other hand, damper grooves 104a, 104b, which are formed in the piston 18a, include recesses 108, into which the jutting portions 96 are inserted, the recesses 108 being formed within second grooves 106 into which the guide members 94 are inserted. The recesses 108 are formed in substantially semicircular cross sectional shapes, being recessed in directions toward both end surface sides of the piston 18a (see FIG. 10).

Furthermore, on the base member 98 that makes up the dampers 102a, 102b, tapered portions 100 are formed, which gradually are reduced in width in a direction away from the guide members 94, the tapered portions 100 extending along the base member 98. On the other hand, in first grooves 110 of the damper grooves 104a, 104b, tapered surfaces 112 are formed with predetermined angles of inclination corresponding to the form of the tapered portions 100. The tapered surfaces 112 are formed such that the first grooves 110 gradually narrow in width toward the end surface sides of the piston 18a.

In this manner, by providing the jutting portions 96 on the guide members 94 of the dampers 102a, 102b, and by engagement of the jutting portions 96 within the recesses 108 formed in the damper grooves 104a, 104b, even in the case that the dampers 102a, 102b are pulled in directions to separate from the damper grooves 104a, 104b of the piston 18a (in directions of the arrows A and B), because the jutting portions 96 are caught within the recesses 108, detachment of the dampers 102a, 120b from the piston 18a can further be reliably prevented.

Further, by providing the tapered portions 100 on the base member 98 constituting the dampers 102a, 102b, and through engagement of the tapered portions 100 with respect to the tapered surfaces 112 of the first grooves 110 that make up the damper grooves 104a, 104b, even in the case that the dampers 102a, 102b are pulled in directions to separate from the damper grooves 104a, 104b of the piston 18a (in directions of the arrows A and B), as a result of engagement by the tapered portions 100, detachment of the dampers 102a, 120b from the piston 18a can be even more reliably prevented.

The invention is not limited to the above-described case, in which jutting portions 96 and tapered portions 100 are provided together on the dampers 102a, 102b. It is also possible to prevent detachment of the dampers 102a, 102b from the piston 18a in the case that only one of them, either the jutting portions 96 or the tapered portions 100, is provided.

Next, in the case that the piston 18, with the pair of dampers 72a, 72b installed thereon, is inserted into the cylinder tube 12 and the head and rod covers 14, 16 are assembled onto both ends of the cylinder tube 12, the head cover 14 is inserted through the cylinder hole 20 from one end side of the cylinder tube 12, and is pressed into the interior of the cylinder hole 20 toward the piston 18 (in the direction of the arrow B), until the projections 38a thereof abut against the stepped portion 24 of the recesses 22a disposed in the cylinder hole 20. Further, after the projections 38a abut against the stepped portion 24 and displacement of the head cover 14 toward the other end side of the cylinder tube 12 that forms the piston 18 side thereof (in the direction of the arrow B) is regulated, the locking ring 28a is inserted into the cylinder hole 20 and is installed in the ring groove 26 from the one end side of the cylinder tube 12.

In this case, the arm sections 86 and the claw portions 88 are deformed in directions so as to approach one another by a jig (not shown), which is inserted into the pair of jig holes 92, and after the locking ring 28a has been inserted up to a position alongside the ring groove 26, the locking ring 28a is deformed again by releasing the held state of the arm sections 86 by the jig, whereupon due to its elasticity the locking ring 28a expands radially outward and engages within the ring groove 26.

Accordingly, displacement of the head cover 14 toward the inside of the cylinder tube 12 (in the direction of the arrow B) is regulated in the axial direction by engagement of the projections 38a of the head cover 14 within the recesses 22a of the cylinder hole 20. Moreover, displacement of the head cover 14 outside of the cylinder tube 12 (in the direction of the arrow A) also is regulated by the locking ring 28a installed within the ring groove 26. That is, the head cover 14 becomes fixed into one end side of the cylinder tube 12, and is accommodated therein without protruding outwardly from the end of the cylinder tube 12.

Further, because the rod cover 16 is guided along the cylinder hole 20 by the plurality of guide members 49 disposed on the outer circumferential surface thereof, the axis of the rod hole 42 in the rod cover 16 and the center of the cylinder hole 20 can suitably be made to coincide with each other, so that the piston rod 44 that is inserted through the cylinder hole 20 can easily and reliably be inserted with respect to the rod hole 42.

On the other hand, the rod cover 16 is inserted through the cylinder hole 20 from the other end side of the cylinder tube 12, while the piston rod 44 is inserted through the rod hole 42, and the rod cover 16 is pressed into the interior of the cylinder hole 20 toward the piston 18 (in the direction of the arrow A), until the projections 38b thereof abut against the stepped portion 24 of the recesses 22b disposed in the cylinder hole 20. In addition, after the projections 38b abut against the stepped portion 24 of the recess 22b and displacement of the rod cover 16 toward the one end side of the cylinder tube 12 that forms a piston 18 side thereof (in the direction of the arrow A) is regulated, the locking ring 28b is inserted into the cylinder hole 20 and is installed in the ring groove 26 from the other end side of the cylinder tube 12. In this case, the arm sections 86 and the claw sections 88 are deformed in directions so as to mutually approach one another by the jig (not shown), which is inserted into the pair of jig holes 92, and after the locking ring 28b has been inserted up to a position alongside the ring groove 26, the locking ring 28b is deformed again by releasing the held state of the arm portions 86 by the jig, whereupon due to its elasticity the locking ring 28b expands radially outward and engages within the ring groove 26.

Accordingly, displacement of the rod cover 16 toward the inside of the cylinder tube 12 (in the direction of the arrow A) is regulated in the axial direction by engagement of the projections 38b of the rod cover 16 within the recesses 22b of the cylinder hole 20. Moreover, displacement of the rod cover 16 outside of the cylinder tube 12 (in the direction of the arrow B) also is regulated by the locking ring 28b installed within the ring groove 26. That is, the rod cover 16 becomes fixed into the other end side of the cylinder tube 12, and is accommodated therein without protruding outwardly from the other end of the cylinder tube 12.

In this manner, when the head cover 14 and the rod cover 16 are installed onto both ends of the cylinder tube 12, the pairs of projections 38a, 38b are made to engage respectively within the pairs of recesses 22a, 22b provided in the cylinder hole 20 of the cylinder tube 12, and the locking rings 28a, 28b, which are inserted from ends of the cylinder hole 20, are made to engage within the ring grooves 26, whereby displacements of the head cover 14 and the rod cover 16 in axial directions can easily and reliably be regulated.

Next, explanations shall be given concerning operations and effects of the fluid pressure cylinder 10, which has been assembled in the foregoing manner. Such explanations shall be made assuming the state shown in FIG. 3, in which the piston 18 is displaced toward the side of the head cover 14 (in the direction of the arrow A), is taken as an initial position.

First, pressure fluid from an unillustrated pressure fluid supply source is introduced into the first fluid port 30. In this case, the second port 32 is placed in a state of being open to atmosphere, under a switching action of an unillustrated directional control valve. As a result, the pressure fluid is introduced to the interior of the cylinder hole 20 from the first fluid port 30 through the communication passage 34, whereupon the piston 18 is pressed toward the side of the rod cover 16 (in the direction of the arrow B) by the pressure fluid introduced between the head cover 14 and the piston 18. Additionally, by abutment of the damper 72b installed at the end surface of the piston 18 against the end surface of the rod cover 16, the displacement of the piston 18 reaches the regulated displacement terminal end position thereof. At this time, shocks generated upon abutment are buffered by the damper 72b, and such shocks are prevented from exerting an impact on the piston 18.

On the other hand, in the event that the piston 18 is displaced in the opposite direction (in the direction of the arrow A), pressure fluid is supplied to the second fluid port 32, while the first fluid port 30 is placed in a state of being open to atmosphere, under a switching action of the directional control valve (not shown). The pressure fluid is supplied to the interior of the cylinder hole 20 from the second fluid port 32 through the communication passage 34, whereupon the piston 18 is pressed toward the side of the head cover 14 (in the direction of the arrow A) by the pressure fluid introduced between the rod cover 16 and the piston 18. Additionally, upon displacement of the piston 18, the piston rod 44 and the damper 72a are displaced integrally toward the side of the head cover 14, and by abutment of the damper 72a that confronts the head cover 14 against the end surface of the head cover 14, the displacement of the piston 18 reaches the regulated displacement terminal end position thereof. At this time, similarly, shocks generated upon abutment are buffered by the damper 72a, and such shocks are prevented from exerting an impact on the piston 18.

In the above manner, in the present embodiment, damper grooves 70a, 70b are disposed respectively along both end surfaces of the piston 18, whereby the damper grooves 70a, 70b are formed from first grooves 74, which open on both of the end surfaces, and second grooves 76, which are adjacent to and expanded in width with respect to the first grooves 74. The dampers 72a, 72a are slidably displaced with respect to the damper grooves 70a, 70b and the guide member 82 is inserted in the second groove 76 formed on the inner side of the piston 18, whereas the base member 80 is inserted into the first groove 74, and accordingly, the dampers 72a, 72b are easily installed onto the piston 18.

Further, the dampers 72a, 72b can reliably be fixed with respect to the piston 18 using a simple structure, in which damper grooves 70a, 70b are formed on both end surfaces of the piston 18, and wherein the dampers 72a, 72b that are installed in the damper grooves 70a, 70b are equipped with base members 80 and guide members 82. Owing thereto, compared with the damper fixing method utilized in the conventional fluid pressure cylinder, the dampers 72a, 72b are capable of being fixed by means of a simplified structure and at a low cost.

Moreover, because the dampers 72a, 72b have the guide members 82, which are expanded in width with respect to the base members 80, and the guide members 82 engage within the second grooves 76, the dampers 72a, 72b are prevented from being displaced in the axial direction (the direction of the arrows A and B) with respect to the piston 18. Owing thereto, the pair of dampers 72a, 72b that are installed on both end surfaces of the piston 18 can normally be displaced together with the piston 18.

Still further, because the dampers 72a, 72b are surrounded by the inner circumferential surface of the cylinder hole 20 in a state in which the dampers 72a, 72b are installed in the damper grooves 70a, 70b of the piston 18, the dampers 72a, 72b are prevented from being displaced along the damper grooves 70a, 70b. That is, the pair of dampers 72a, 72b normally are installed integrally therewith and do not become separated from the piston 18 at the interior of the cylinder tube 12.

Furthermore, because the dampers 72a, 72b are formed with substantially rectangular shapes in cross section, and are configured to be slidably displaceable with respect to the damper grooves 70a, 70b, compared with the cushion dampers in the conventional fluid pressure cylinder, it can be assured that the surface areas of the dampers 72a, 72b that confront the head cover 14 and the rod cover 16 are sufficiently large. As a result, a predetermined buffering capability, by which shocks with respect to the piston 18 are buffered by the dampers 72a, 72b, can be assured.

Although a case has been described in which, in the aforementioned fluid pressure cylinder 10, the dampers 72a, 72b are disposed on both end surfaces of the piston 18, the invention is not limited to such a feature. It is also acceptable for damper grooves to be formed on end surfaces of the head cover 14 and the rod cover 16, respectively, facing toward both end surfaces of the piston 18, whereby the dampers 72a, 72b are installed therein.

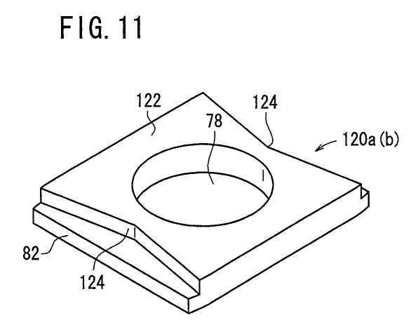

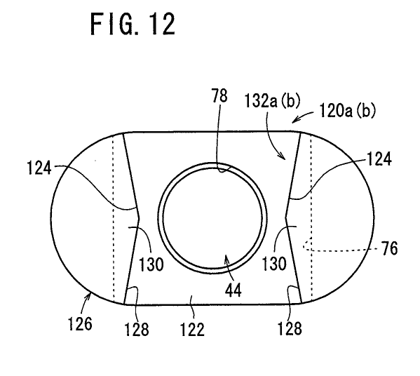

Further, as shown in FIGS. 11 and 12, the base member 122 of the dampers 120a, 120b may be formed with a pair of V-grooves 124 therein, whereas a pair of projections 130 are formed in first grooves 128 of a piston 126 into which the dampers 120a, 120b are installed, such that the V-grooves 124 are made to engage, respectively, with respect to the projections 130.

The V-grooves 124 are formed so as to gradually become reduced in width from both end portions of the dampers 120a, 120b, such that the central portion of the base member 122 is narrowest in width and is formed adjacent to the hole 78. On the other hand, the projections 130 are formed with substantially triangular shapes in cross section, corresponding to the shapes of the V-grooves 124, such that regions thereof facing the hole 78 of the dampers 120a, 120b project most prominently toward the sides of the dampers 120a, 120b.

Accordingly, in a state in which the dampers 120a, 120b are installed in damper grooves 132a, 132b, because the pair of V-grooves 124 engages respectively with the projections 130 of the piston 126, the dampers 120a, 120b can be fixed even more reliably with respect to the piston 126. Specifically, even in the case that the dampers 120a, 120b are pulled along the extending direction of the damper grooves 132a, 132b, because the V-grooves 124 are engaged with respect to the projections 130 of the piston 126, the dampers 120a, 120b do not become separated from the damper grooves 132a, 132b.

The locking rings 28a, 28b that lock the head cover 14 and the rod cover 16 with respect to the cylinder tube 12 are not limited to the above-described configuration, including the bulging portions 90 and the jig holes 92 located at intermediate positions on the pair of arm sections 86 thereof.

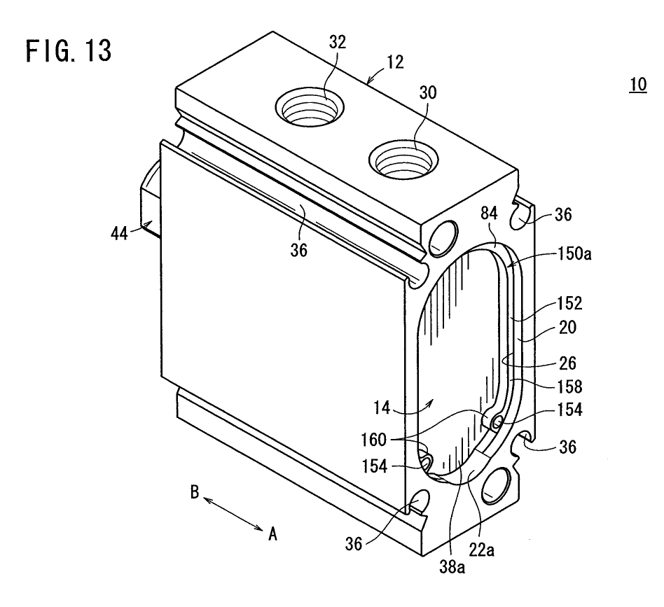

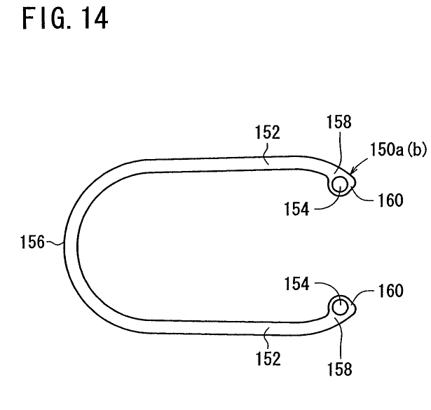

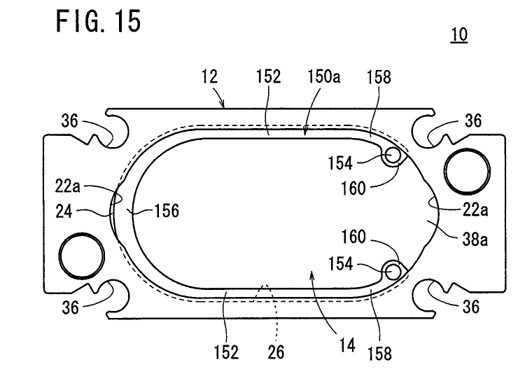

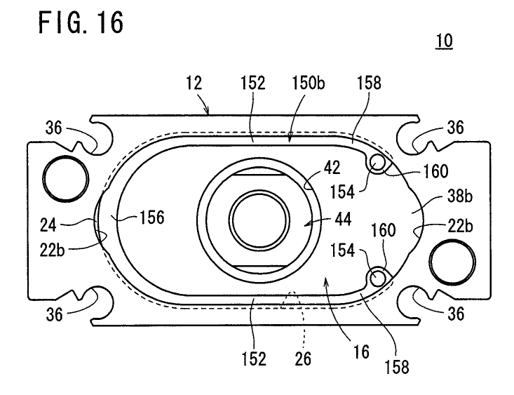

For example, locking rings 150a, 150b, such as those shown in FIGS. 13 to 16, which include jig holes 154 provided respectively on both ends of arm sections 152, may also be adopted.

Such locking rings 150a, 150b, as shown in FIGS. 13 to 16, are formed with substantially U-shaped cross sections from a metallic material, and are installed respectively into a pair of ring grooves 26, which are formed in the cylinder hole 20 of the cylinder tube 12 (see FIG. 13).

The locking rings 150a, 150b are formed with shapes corresponding to the ring grooves 26, and include a bent section 156, which is bent at a predetermined radius of curvature, a pair of arm sections 152 that extend in substantially straight lines from both ends of the bent section 156, and a pair of claw sections 158 disposed on ends of the arm sections 152, which are bent at a predetermined radius of curvature and are mutually separated a predetermined distance from each other. The claw sections 158 are positioned in confronting relation to the bent section 156 sandwiching the arm sections 152 therebetween, and the locking rings 150a, 150b possess a certain elasticity, which urges the pair of claw sections 158 themselves mutually in directions to separate a predetermined distance away from each other. The bent section 156 has the same structure as the bent section 84 constituting the locking rings 28a, 28b, and thus detailed explanations of this feature are omitted.

The claw sections 158 include bulging portions 160 which bulge toward the inner side surface of the claw sections 158 in a mutually facing relation to each other. Jig holes 154 are formed respectively in each of the bulging portions 160. In addition, by inserting an unillustrated jig into the pair of jig holes 154 and displacing the bulging portions 160 along with the jig holes 154 mutually in directions to approach one another, the arm sections 152 and the claw sections 158 can be elastically deformed so as to approach mutually toward each other about the junctures at the bent section 156.

In addition, the locking rings 150a, 150b are installed respectively into the ring grooves 26 after the head cover 14 and the rod cover 16 have been installed with respect to the cylinder hole 20 of the cylinder tube 12. Accordingly, the head cover 14 and the rod cover 16 are fixed by means of the projections 38a, 38b thereof and the locking rings 150a, 150b. At this time, the head cover 14 and the rod cover 16 do not protrude from the end surfaces of the cylinder tube 12.

The dampers 72a, 72b for use in the fluid pressure cylinder 10 according to the present invention are not limited to the aforementioned embodiments, and naturally various other configurations may be adopted without departing from the essential features and gist of the present invention.

What is claimed is:

1. A damper fixing mechanism disposed in a fluid pressure cylinder for fixing a damper that buffers shocks occurring when a piston abuts against a cover member installed on an end of a cylinder body, said piston being installed inside of said cylinder body and displaced in said fluid pressure cylinder by a pressure fluid, the damper fixing mechanism comprising:
a damper groove formed on an end surface of said piston facing said cover member, and extending substantially perpendicular to an axis of said piston, the damper groove including:
a first groove opened on a side of said end surface; and
a second groove lying adjacent to and expanded in width with respect to said first groove;
said damper comprising:
a base member inserted into said first groove; and
a guide member inserted into said second groove and expanded in width with respect to said base member.

2. The damper fixing mechanism according to claim 1, wherein said guide member comprises a pair of guide members disposed on both sides of said base member.

3. The damper fixing mechanism according to claim 2, wherein said guide member includes a jutting portion that projects toward the side of said base member, said jutting portion being inserted into a recess formed in said second groove on the side of the end surface of said piston.

4. The damper fixing mechanism according to claim 3, wherein said base member includes a tapered portion, which gradually narrows in width in a direction away from said guide member, said first groove into which said base member is inserted being formed in a tapered shape that gradually narrows in width toward said end surface side corresponding to said tapered portion.

5. The damper fixing mechanism according to claim 1, wherein said damper is disposed in said fluid pressure cylinder comprising said piston formed with a substantially elliptical shape in cross section, said cylinder body having a substantially cross sectional elliptically shaped cylinder chamber in which said piston is inserted, and said substantially cross sectional elliptically shaped cover members that close both ends of said cylinder chamber.

6. The damper fixing mechanism according to claim 1, wherein said base member includes a pair of V-grooves, which are recessed into sides of said base member, said V-grooves engaging respectively with a pair of projections formed in said first groove.

7. A damper fixing mechanism disposed in a fluid pressure cylinder for fixing a damper that buffers shocks occurring when a piston abuts against a cover member installed on an end of a cylinder body, said piston being installed inside of said cylinder body and displaced in said fluid pressure cylinder by a pressure fluid, the damper fixing mechanism comprising:
a damper groove formed on an end surface of said cover member facing said piston, and extending substantially perpendicular to an axis of said cover member, the damper groove including:
a first groove opened on a side of said end surface; and
a second groove lying adjacent to and expanded in width with respect to said first groove;
said damper comprising:
a base member inserted into said first groove; and
a guide member inserted into said second groove and expanded in width with respect to said base member.
